(19) United States
(12) Patent Application Publication
(10) Pub. No.: US 2009/0110005 A1
(43) Pub. Date: Apr. 30, 2009

(54) SWITCHING CIRCUIT AND SWITCHING METHOD

(76) Inventor: SHUHEI HORIKOSHI, Tokyo (JP)

Correspondence Address: NEC CORPORATION OF AMERICA, 6535 N. STATE HWY 161, IRVING, TX, 75039, US

(21) Appl. No.: 12/256,191

(22) Filed: Oct. 22, 2008

(30) Foreign Application Priority Data
Oct. 30, 2007 (JP) 2007-281875

(51) Int. Cl. H04J 13/00

(52) U.S. Cl. 370/479

(57) ABSTRACT

Timing control means receives a plurality of data that have been input in parallel and adjusts the timings of a plurality of the data so that data having the same destination do not exist at the same timing. Multiplexing means generates a multiple signal by multiplying the data whose timings have been adjusted in the timing control means by an orthogonal code that has been determined for each destination and then by multiplexing data being at the same timing together. Separating means extracts a datum for each destination from the multiple signal, by multiplying the multiple signal by an orthogonal code for each destination.

This application is based upon and claims the benefit of priority from Japanese Patent Application No. 2007-281875 filed on Oct. 30, 2007, the content of which is incorporated by reference.

### BACKGROUND OF THE INVENTION

1. Field of the Invention

The present invention relates to a switching technology for distributing input data into a plurality of destinations.

2. Description of the Related Art

Many communication devices constituting a communication system are provided with a switching circuit which distributes input data into destinations (See Japanese Patent Application Laid-Open No. 10-13867). For instance, a base station of a communication system of a digital portable telephone such as W-CDMA (Wideband-Code Division Multiple Access) is provided with a switching circuit which distributes input packets into each destination.

This sort of a switching circuit is required to have a high throughput capability capable of treating a large amount of small packets at a low cost. In addition, this sort of the switching circuit is also required to intensively treat input packets in a burst manner in a short time.

However, the above described technology has the following problems.

The greater the number of channels that are input into the switching circuit, the higher is the possibility that more packets will be input into the switching circuit at the same time. It is hereinafter referred to as “bursty input” in which a plurality of packets are input into the switching circuit at the same time.

Baseband processing such as a switching operation for packets is limitated in increasing its output throughput because the maximum throughput of output is determined by the operation speed of the circuit. A general switching circuit temporarily stores the burst-input packets in an internal RAM (Random Access Memory), sequentially processes them, and outputs the packets to destinations. For this reason, a communication device for a network, which has a large number of input channels and in which bursty input occurs, creates a state in which the packets are caused to remain internal RAM.

The greater the number of burst-input packets, the longer is the period of time in which the packets remains in internal RAM and the longer is the delay time until the packets are input into the switching circuit. In addition, if packet that remain in RAM cause a RAM region to be no longer available, the packet cannot be input into RAM which would create a lockout condition, which may further lengthen the delay time and may make the internal RAM overflow. When the capacity of the internal RAM is increased so as to prevent lockout and the overflow, the circuit scale increases as well as the cost of the device.

### SUMMARY OF THE INVENTION

An exemplary object of the present invention is to provide a switching circuit for mitigating the effect of the data remains in the circuit and a switching method therefor.

In order to achieve the object, a switching circuit according to the exemplary aspect of the present invention includes:

timing control means which receives a plurality of data that have been input in parallel and adjusts the timings of the plurality of the data so that data having the same destination do not exist at the same timing;

multiplexing means which generates a multiple signal by multiplying the data whose timings have been adjusted in the timing control means by an orthogonal code that has been determined for each destination and then multiplexing data being at the same timing together; and

separating means which extracts a datum for each destination from the multiple signal, by multiplying the multiple signal by the orthogonal code for each destination.

A switching method according to an exemplary aspect of the present invention includes:

receiving a plurality of data which have been input in parallel, and adjusting the timings of the plurality of the data so that data having the same destination do not exist at the same timing;

generating a multiple signal by multiplying the data whose timings have been adjusted by an orthogonal code that has been determined for each destination, and then multiplexing data being at the same timing together; and

extracting a datum for each destination from the multiple signal, by multiplying the multiple signal by the orthogonal code for each destination.

The above and other objects, features, and advantages of the present invention will become apparent from the following description with references to the accompanying drawings which illustrate examples of the present invention.

### BRIEF DESCRIPTION OF THE DRAWINGS

FIG. 1 is a block diagram illustrating a configuration of a switching circuit according to an exemplary embodiment;

FIG. 2 is a flow chart illustrating an operation of a switching circuit according to the exemplary embodiment;

FIG. 3 is a block diagram illustrating a configuration of a spatio-temporal-coding switching circuit according to an example;

FIG. 4 is a block diagram illustrating a configuration of a packet-input timing controller according to the present example;

FIG. 5 is a block diagram illustrating a configuration of an orthogonal-coding switching memory section according to the present example;

FIG. 6 is diagram for describing an operation example of bus width conversion/synchronization FIFO 201 to 203;

FIG. 7A is a conceptual diagram illustrating an operation example of a switching circuit which adopts a configuration of storing input packets in an internal RAM, sequentially processing them and outputting them, as a comparative example against the present example;

FIG. 7B is a conceptual diagram illustrating an operation example of a switching circuit which adopts a configuration according to the present example;

FIG. 8A is a conceptual diagram illustrating an operation example of a switching circuit which adopts a configuration of storing an input packet in an internal RAM, sequentially processing them and outputting them, as a comparative example against the present example; and

FIG. 8B is a conceptual diagram illustrating an operation example of a switching circuit which adopts a configuration according to the present example.

### DETAILED DESCRIPTION OF THE PREFERRED EMBODIMENTS

An exemplary embodiment for carrying out an invention will now be described below in detail with reference to the drawings.

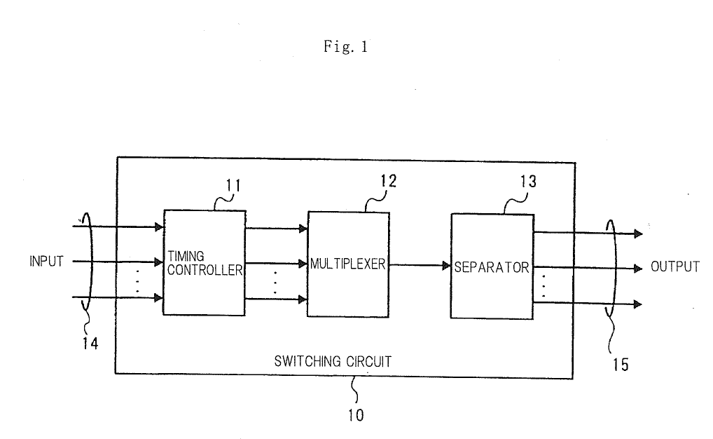

FIG. 1 is a block diagram illustrating a configuration of a switching circuit according to the exemplary embodiment. With reference to FIG. 1, switching circuit 10 has timing controller 11, multiplexer 12 and separator 13. Switching circuit 10 includes a plurality of input lines 14 and a plurality of output lines 15; and switches packets input from the plurality of input lines 14, and distributes a packet to desired output line 15 among the plurality of output lines.

Timings of the packets input from the plurality of input lines 14 are asynchronous to each other. Packets to be output to the same destination can be input from the plurality of input lines 14. Furthermore, the packets to be output to the same destination can be input from the plurality of input lines 14 at the same time as well.

Timing controller 11 synchronizes the timings of the packets input from the plurality of input lines 14, and adjusts the timings of the packets so that a plurality of packets having the same destination do not exist at the same timing.

Multiplexer 12 generates multiple signals by multiplying the packet whose timing has been adjusted in timing controller 11 by each orthogonal code that is determined for each destination and then multiplexing the packets being at the same timing together. The multiple signals may be obtained, for instance, by synthesizing a plurality of signals obtained by multiplying the packets by the orthogonal code. The orthogonal code is a code orthogonal to each other, and all orthogonal codes for each destination are orthogonal to each other. Examples of the orthogonal code include a Gold code and a Walsh-Hadamard code.

Separator 13 extracts a packet for each destination from multiple signals by multiplying the multiple signals in which packets are multiplexed in multiplexer 12 by each orthogonal code for each destination, and outputs the extracted packet from output line 15 for the destination corresponding to the orthogonal code which has been used for extracting the packet.

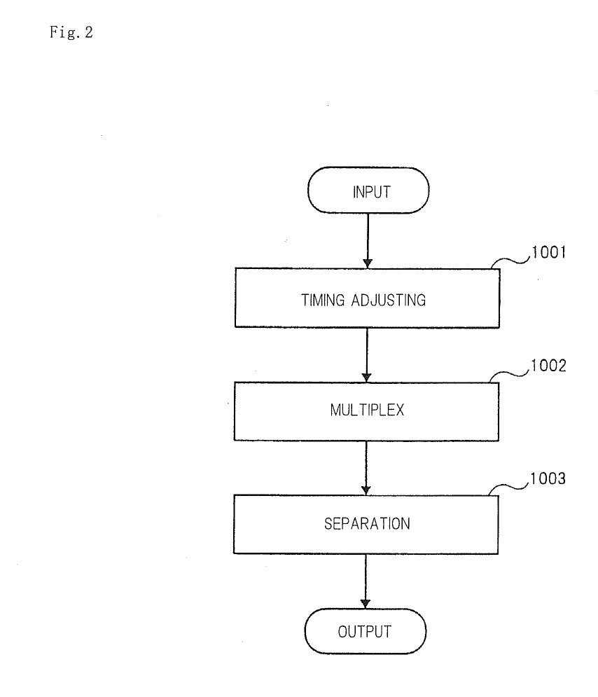

FIG. 2 is a flow chart illustrating an operation of a switching circuit according to the exemplary embodiment. With reference to FIG. 2, switching circuit 10 synchronizes the timings of packets which are input from a plurality of input lines 14, and adjusts the timings of the packets so that a plurality of packets having the same destination do not exist at the same timing (step 1001).

Subsequently, switching circuit 10 multiplies the packets of which the timings have been adjusted by each orthogonal code that is determined for each destination, and then multiplexes the packets being at the same timing together (step 1002). Furthermore, switching circuit 10 extracts a packet for each destination by multiplying the multiple signals in which packets are multiplexed by each orthogonal code for each destination, and outputs the extracted packet from output line 15 corresponding to the destination (step 1003).

As described above, switching circuit 10 of the exemplary embodiment synchronizes the timings of the packets input from a plurality of input lines 14, simultaneously adjusts the timings of the packets so that packets to be output to the same destination do not exist at the same timing, and multiplexes each packet by multiplying the packet by an orthogonal code corresponding to the destination. Switching circuit 10 extracts a packet for each destination by multiplying multiple signals in which packets are multiplexed by an orthogonal code, and outputs the extracted packet from output line 15 corresponding to the destination. Therefore, the switching circuit according to the exemplary embodiment multiplexes the packets which are input from the plurality of input lines 14 by using correlation characteristics of the orthogonal code, processes the multiplexed packets in parallel and distributes the multiplexed packets to a plurality of output lines 15; and consequently decreases the number of packets which stay in the circuit when the bursty input of the packets has occurred, and can mitigate the influence of packets that remain in the circuit, such as the influence of packets delays, and increase memory capacity.

Specific examples of the exemplary embodiment will now be described below. The present example illustrates a spatio-temporal-coding switching circuit which is provided on the base station of a W-CDMA mobile communication system.

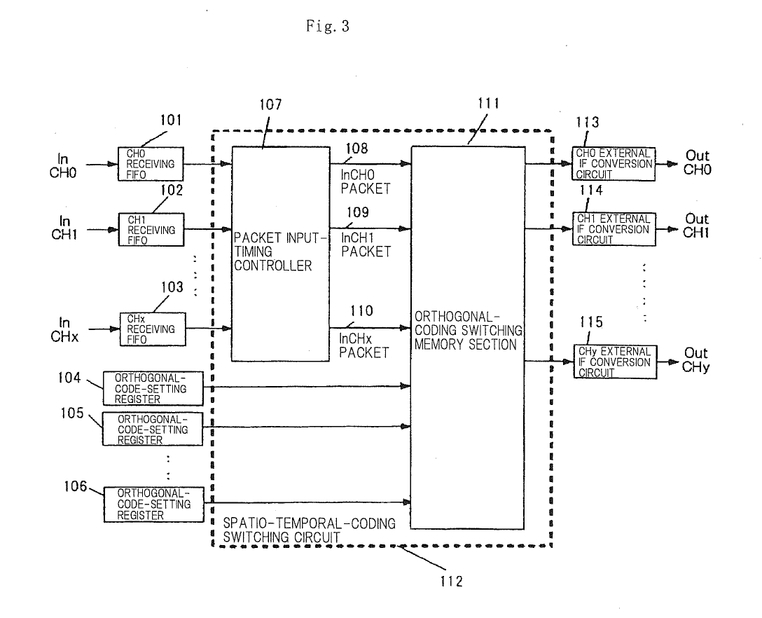

FIG. 3 is a block diagram illustrating a configuration of a spatio-temporal-coding switching circuit according to the present example. Spatio-temporal-coding switching circuit 112 according to the present example includes (x+1) input channels and (y+1) output channels.

With reference to FIG. 3, spatio-temporal-coding switching circuit 112 includes packet input-timing controller 107 and orthogonal-coding switching memory section 111. Packet input-timing controller 107 corresponds to timing controller 11 of FIG. 1. Orthogonal-coding switching memory section 111 corresponds to multiplexer 12 and separator 13 of FIG. 1.

Spatio-temporal-coding switching circuit 112 is connected with (x+1) pieces of receiving FIFOs (First In First Out) 101 to 103, (y+1) pieces of external IF conversion circuits 113 to 115, and (x+1+y+1) pieces of orthogonal-code-setting registers 104 to 106.

Packets having been input into CH0 to CHx are deserialized by SerDes (serializer/deserializer) circuit (not shown) and are input into receiving FIFOs 101 to 103. In each receiving FIFOs 101-103, the packets on an external clock are transferred onto an internal clock. The packets which have been transferred onto the internal clock are synchronized by the internal clock and are input into packet input-timing controller 107.

Packet input-timing controller 107 manages and controls the timings of the packets sent from receiving FIFOs 101 to 103 of each channel. Specifically, packet input-timing controller 107 synchronizes packets sent from receiving FIFOs 101 to 103 in a plurality of channels with each other. Packet input-timing controller 107 also controls the timings of a plurality of packets having the same destination existing at the same timing, if there are, so that the timings of the packets differ from each other. The packets sent from packet input-timing controller 107 are input into orthogonal-code-multiplexing memory section 111.

An orthogonal code which is set in external orthogonal-code-setting registers 104 to 106 is already input in orthogonal-code-multiplexing memory section 111. Each of orthogonal-code-setting registers 104 to 106 is formed of a writable and readable RAM, for instance, and can freely set a value of the orthogonal code therein. The orthogonal-code-setting register may freely set an orthogonal code such as a Gold code and a Walsh-Hadamard code, for instance, according to the number of channels used at the same time and the bus width of the memory, which is determined so as to correspond to a code length. The orthogonal-code multiplexing memory can flexibly and freely select the destination, by arbitrarily setting the value of the orthogonal codes in orthogonal-code-setting registers 104 to 106.

Orthogonal-code-setting registers 104 to 106 include a register for use in multiplexing packets and a register for use in separating the packets. Orthogonal-code-multiplexing memory section 111 multiplies the packet of each input channel (InCH0 108 to InCHx 110) by an orthogonal code that is input from the register for multiplexing packets, and which corresponds to each channel, multiplexes the packet of each input channel, which has been multiplied by the orthogonal code, and accumulates the obtained multiple signal therein. Orthogonal-code-multiplexing memory section 111 extracts a packet to be output to each output channel from the multiple signals by multiplying the accumulated multiple signals by an orthogonal code which is input from the register for separating packets.

The packets for each output channel, which have been extracted in orthogonal-coding switching memory section 111, are output through external IF conversion circuits 113 to 115.

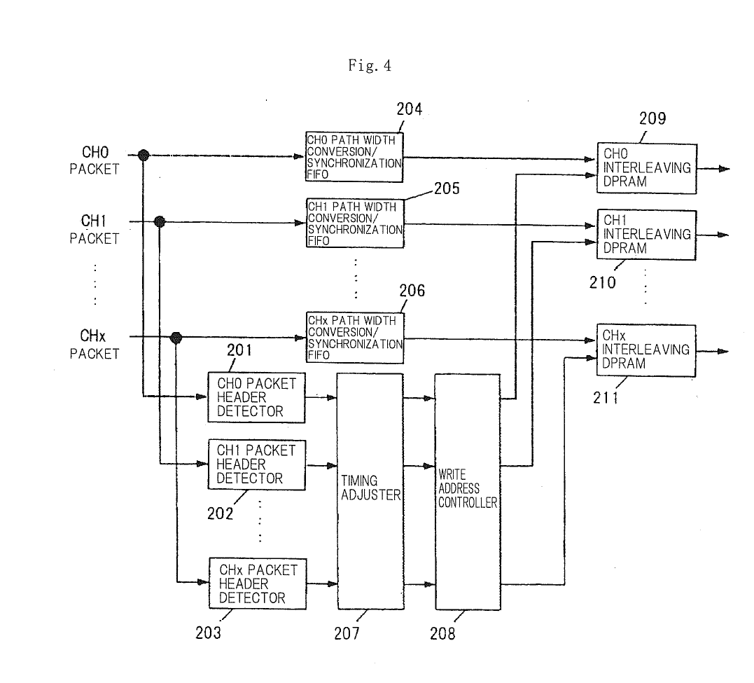

FIG. 4 is a block diagram illustrating a configuration of a packet input-timing controller according to the present example. Packet input-timing controller 107 has (x+1) pieces of packet header detectors 201 to 203, (x+1) pieces of bus width conversion/synchronization FIFOs 204 to 206, timing adjuster 207, write address controller 208, and (x+1) pieces of interleaving DPRAMs 209 to 211.

The packets which have been input into packet input-timing controller 107 from receiving FIFOs 101 to 103 are input into bus width conversion/synchronization FIFOs 204 to 206 and packet header detectors 201 to 203.

Bus width conversion/synchronization FIFOs 204 to 206 synchronize the timings of the packets input from the input channels, and uniformize the bus width of the packets. The purpose of uniformizing the bus width of the packets is to enable the packets to be treated with a common bus width in later circuits.

Packet header detectors 201 to 203 detect the destination of the packet from header information of the packet of each channel, and inform the destination information of the packet of each channel to timing controller 207.

Timing controller 207 generates timing information for specifying a write address to be used when the packets sent from bus width conversion/synchronization FIFOs 204 to 206 are written to interleaving DPRAMs 209 to 211, and informs the timing information to Write address controller 208. Timing controller 207 monitors whether there are packets having the same destination at the same timing, by referencing the destination information which has been informed by packet header detectors 201 to 203, and generates the timing information based on the monitoring result.

When there is no packet having the same destination at the same timing, timing controller 207 generates the timing information in which the timing relationship that is output from bus width conversion/synchronization FIFOs 204 to 206 is maintained.

After detecting the existence of packets having the same destination at the same timing, timing controller 207 generates the timing information in which the timings of the packets are made to differ from each other.

Write address controller 208 outputs write address information to interleaving DPRAMs (Dual-ported RAM) 209 to 211, on the basis of the timing information which has been informed from timing controller 207. The write address information is expressed by such an address value such that the packets having the same destination on the same timing are written on addresses corresponding to different timings from each other.

The write address is assigned by the write address information, which is used when the packets output from bus width conversion/synchronization FIFOs 204 to 206 are written on interleaving DPRAMs 209 to 211. Thereby, interleaving DPRAMs 209 to 211 are in a state in which there is no packet that has the same destination in the address corresponding to the same timing.

Then, a datum is read out from an earlier sequence of memory address from interleaving DPRAMs 209 to 211, and the packet is read out from interleaving DPRAMs 209 to 211 in a state in which there is no packet that has the same destination at the same timing.

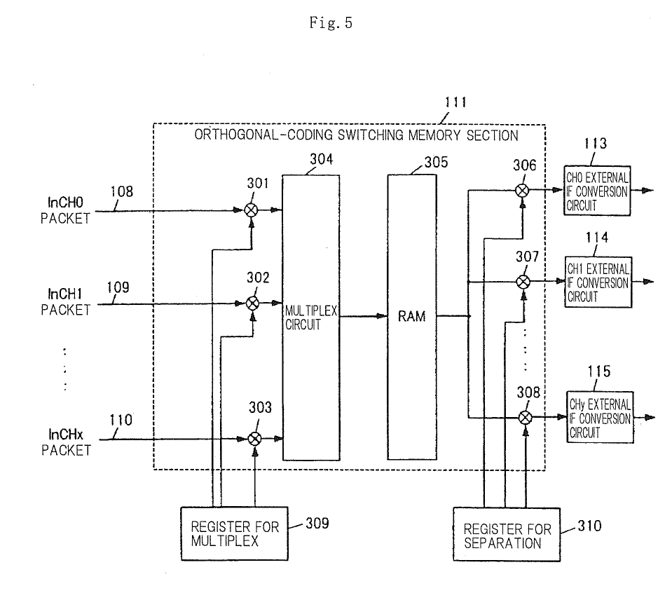

FIG. 5 is a block diagram illustrating a configuration of an orthogonal-coding switching memory section according to the present example. With reference to FIG. 5, orthogonal-coding switching memory section 111 has coding multipliers 301 to 303, multiplex circuit 304, RAM 305 and decoding multipliers 306 to 308.

Each of the packets of each channel, of which the timing has been adjusted in packet input-timing controller 107, is input into coding multipliers 301 to 303. Coding multipliers 301 to 303 multiply the input packet by an orthogonal code which has been input from register 309 for multiplexing packets included in orthogonal-code-setting registers 104 to 106, and diffuse the products.

Multiplex circuit 304 multiplexes each packet which has been multiplied by the orthogonal code in coding multipliers 301 to 303, and writes the obtained multiple signal in RAM 305. RAM 305 accumulates the signal which is in a state in which the packets of each channel have been multiplexed. The multiple signal which has been output from RAM 305 is input into decoding multipliers 306 to 308.

RAM 305 is a memory in which packets, which have been input in a burst manner, when the throughput speed in the output side has been less than the throughput speed in the input side, remain. When the throughput of the output side is more than the speed of the input side, RAM 305 is unnecessary.

In register 310 for separating packets, an orthogonal code of a destination is set so that the packet can be output from a desired output channel. Decoding multipliers 306 to 308 extract the packet having the destination that corresponds to its orthogonal code, by multiplying the multiple signal which has been input from RAM 305 by an orthogonal code which has been input from register 310 for separating packets included in orthogonal-code-setting registers 104 to 106. Switching is realized by extracting the packet having the desired destination from the multiple signal.

In addition, if a condition in which the input channel that has a one to one corresponding relation with the output channel can be satisfied in switching, then register 309 for multiplexing packets and register 310 for separating packets can be commonly used regularly. In the case, the value of the commonly used register may be regularly provided to both a diffusion treatment of the packets of input channels (coding multipliers 301 to 303) and to a back diffusion treatment of the packets of output channels (decoding multipliers 306 to 308).

Alternatively, when packets having a plurality of destinations are input together from the same input channel, register 309 for multiplexing packets may have a structure, for instance, so as to select a register in which orthogonal code is set by synchronizing with the timings of the packet and by switching an existing order to the set register, and so as to provide the value of the selected register to coding multipliers 301 to 303. As for another example, register 309 for multiplexing packets may also have such a structure so as to vary the value which is provided to coding multipliers 301 to 303 in synchronization with the timing of the packet.

The packet which has been extracted in each of decoding multipliers 306 to 308 is input into external IF conversion circuits 113 to 115. External IF conversion circuits 113 to 115 convert the format of the input packet according to an external interface, and then output the resultant packet.

The orthogonal-coding switching memory section causes the packets of a plurality of input channels accumulated in RAM 305 to be in a state of having been multiplexed, and causes decoding multipliers 306 to 308 arranged in parallel to extract a packet of each output channel from the multiple signals; and accordingly does not cause the data quantity to be stayed in RAM 305 to increase and does not cause an increase in delay time even when the bursty input has occurred.

Next, an operation of a spatio-temporal-coding switching circuit according to the present example will now be described below in detail.

With reference to FIG. 3, firstly, deserialized packets are input into receiving FIFOs 101 to 103 from each input channel. The packets are transferred onto a different clock in each of receiving FIFOs 101 to 103. The packets sent from receiving FIFOs 101 to 103 are input into packet input-timing controller 107.

With reference to FIG. 4, the packets sent from receiving FIFOs 101 to 103 are input into packet header detectors 201 to 203 and bus width conversion/synchronization FIFOs 204 to 206.

Packet header detectors 201 to 203 detect destinations of the packets from the header information of the input packets, and inform the destination information to timing adjuster 207. After detecting the existence of packets having the same destination at the same timing, timing adjuster 207 informs such timing information as to differentiate the timings of their packets to write address controller 208.

Write address controller 208 generates such write address information so as to show the addresses of interleaving DPRAMs 209 to 211 which store packets, from the timing information of each channel. The generated write address information is input into interleaving DPRAMs 209 to 211.

The packets which are input into packet input-timing controller 107 are transferred onto the internal clock from the external clock. However, the timings of the packets are not synchronized among channels and the head positions of the packets are not aligned. Bus width conversion/synchronization FIFOs 201 to 203 uniformize the bus width among the channels, and synchronize the timings of the packets. The synchronization FIFOs insert empty data into a packet having a short packet length, in order to uniformize bus widths of all packets and to synchronize the timings of all the packets. The empty data is, for instance, ALL0.

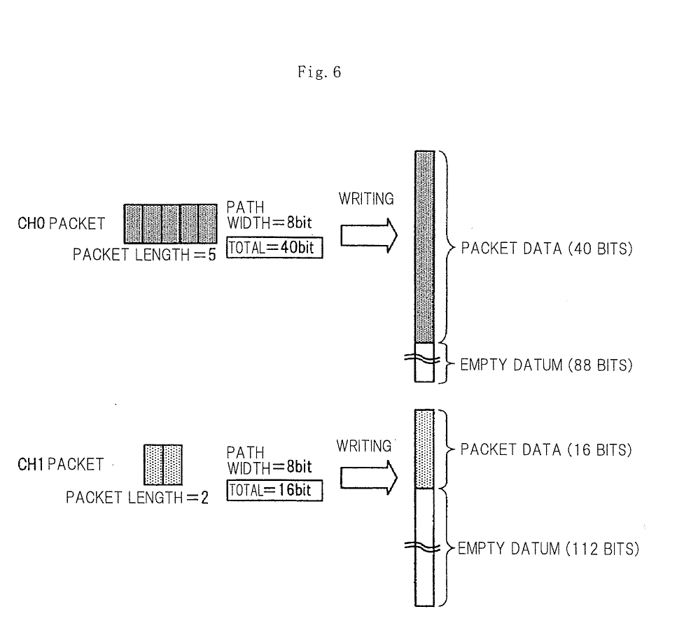

One example of the operation of bus width conversion/synchronization FIFOs 201 to 203 will now be described below. FIG. 6 is a diagram for describing an operation example of bus width conversion/synchronization FIFOs 201 to 203. Here, suppose that a bus width of an internal RAM (not shown) is set at 128 bits. The packet lengths of the input packets are each different, so that the timings are synchronized among the channels and the bus widths are uniformized so that the packets can be multiplied by an orthogonal code and the products can be multiplexed in a synchronized form. In the example of FIG. 6, the packet of CH0 has a packet size of 5, and the packet of CH1 has a packet size of 2. Both CH0 and CH1 have bus widths of 8 bits.

The data quantity of the packet of CH0 is 40 bits. The packet data are stored in a region of 40 bits among 128 bits, and the empty data is inserted into the remaining region of 88 bits. The data quantity of the packet of CH1 is 16 bits. Then, the packet data are stored in a region of 16 bits among 128 bits, and the empty data is inserted into the remaining region of 112 bits. Both CH0 and CH1 packets are stored in a state of being synchronized, as is illustrated in FIG. 6.

Packets of each channel, which have been output from bus width conversion/synchronization FIFOs 204 to 206, are stored in interleaving DPRAMs 209 to 211 respectively according to write address information generated in write address controller 208.

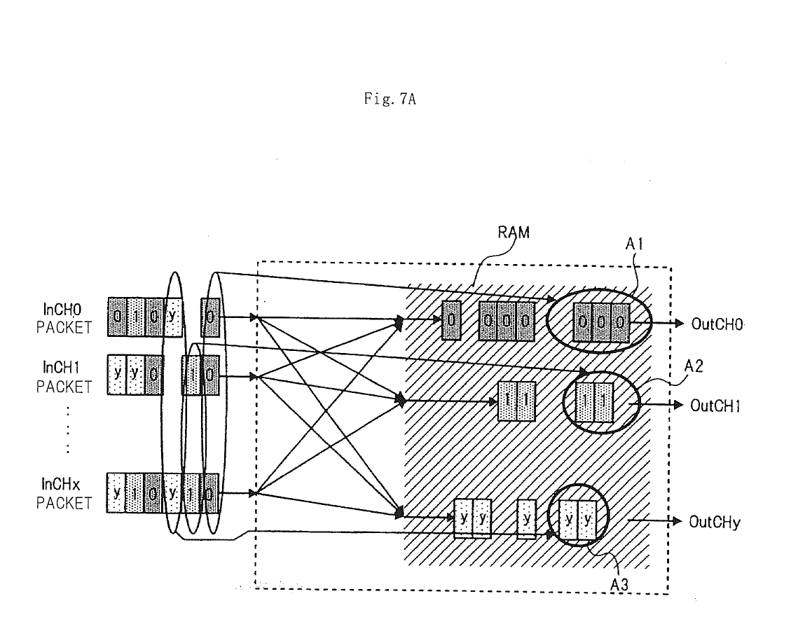

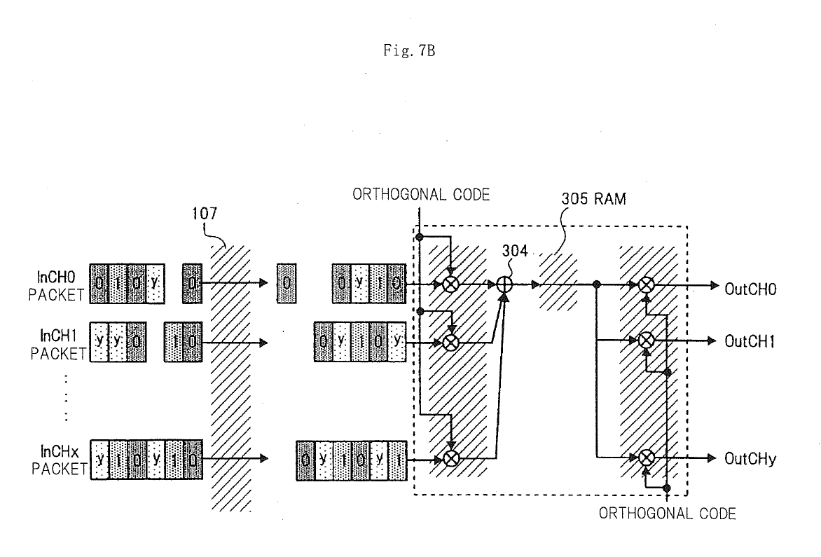

FIG. 7A is a conceptual diagram illustrating an operation example of a switching circuit which adopts a configuration of storing input packets in an internal RAM, sequentially processing them and outputting them, as a comparative example against the present example. FIG. 7B is a conceptual diagram illustrating an operation example of a switching circuit which adopts a configuration according to the present example. In FIGS. 7A and 7B, numerals showing the number of an output channel are described in rectangles for expressing packets.

In a switching circuit of FIG. 7A, the timings of the packets are not adjusted before the packets are input into the RAM, so that when packets that have the same destination are at the same timing, the packets result in staying in the RAM (A1 to A3). On the other hand, in a switching circuit of FIG. 7B, the timings of the packets are adjusted before the packets are input into the RAM, so that even when packets having the same destination are input at the same timing, the packets will not remain in the RAM.

Orthogonal-code-multiplexing switching memory section 111 illustrated in FIG. 5 receives the packets in a state such that the packets are synchronized among channels and such that the packets having the same destination do not exist on the same timing, multiplies the packets by an orthogonal code in a state of maintaining a timing relationship among the channels, multiplexes the packets, and writes the result in RAM 305. The packet processing of each channel in parallel in both of the input side and the output side, and accordingly can conduct a switching processing by staying data of one packet in the RAM.

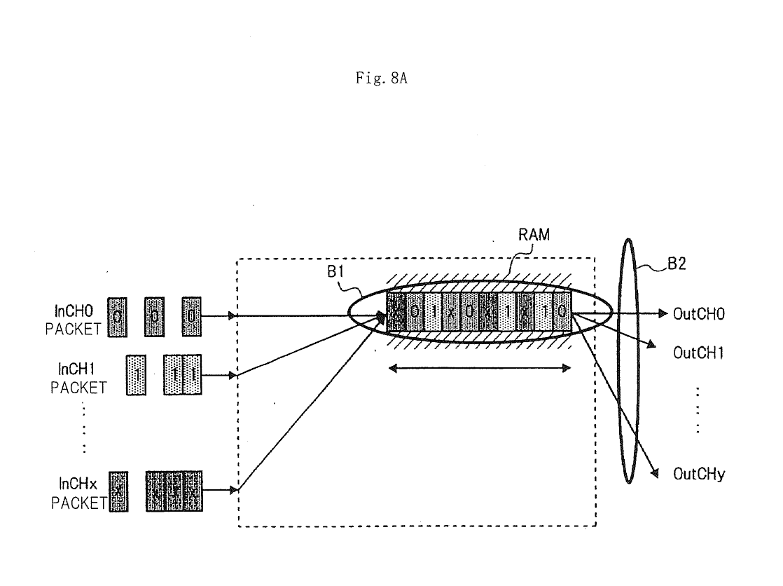

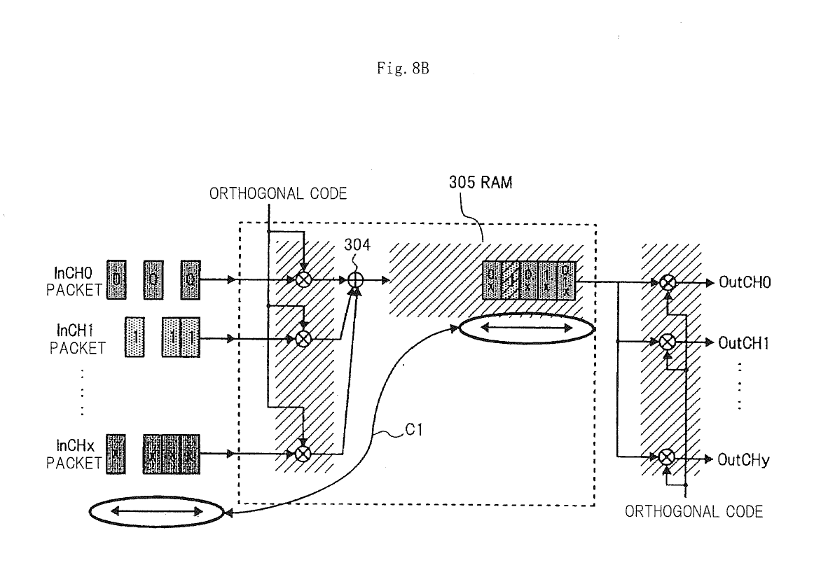

FIG. 8A is a conceptual diagram illustrating an operation example of a switching circuit which adopts a configuration of storing input packets in an internal RAM, and sequentially processing them and outputting them, as a comparative example against the present example. FIG. 8B is a conceptual diagram illustrating an operation example of a switching circuit which adopts a configuration according to the present example. In FIGS. 8A and 8B, numerals showing the number of input channels are described in rectangles of expressing packets. In FIG. 8B, a plurality of numerals are described in some rectangles, which means that packets sent from a plurality of input channels are multiplexed.

A switching circuit of FIG. 8A writes packets sent from each input channel into RAM in an entry sequence. Accordingly, in order to prevent the packets from overflowing when the packets are burst-input, the RAM needs to have a memory capacity that can accumulate the maximum number of packets therein which arrive in a fixed period of time (B1). The switching circuit also serially processes the packets which have been written in the RAM in an entry sequence, in the same entry order, and accordingly causes a delay time in an outputting stage (B2).

On the other hand, a switching circuit of FIG. 8B stores packets in the RAM and conducts switching processing in a state such that the packets of a plurality of channels are multiplexed, so that the RAM may have a memory capacity necessary for storing data of one channel and the packets are processes in a period of time necessary for processing one channel (C1).

In the switching circuit of FIG. 8A, the deviation of usage in a RAM region may possibly occur among channels. When the deviation of usage occurs, the use efficiency of the RAM decreases. On the other hand, the switching circuit of FIG. 8B multiplexes the packets of the plurality of channels to store the packets in RAM, and accordingly does not cause deviation of the usage in the RAM region by deviation of the packet quantity among the channels. The switching circuit can also increase the number of the input channels without increasing the RAM region and without prolonging the processing time.

While preferred exemplary embodiments of the present invention have been described using specific terms, such description is for illustrative purposes only, and it is to be understood that changes and variations may be made without departing from the spirit or scope of the following claims.

What is claimed is:

1. A switching circuit comprising:
a timing controller which receives a plurality of data that are input in parallel and which adjusts the timings of the plurality of the data so that data having the same destination do not exist at the same timing;
a multiplexer which generates a multiple signal by multiplying the data whose timings have been adjusted in the timing controller by an orthogonal code that has been determined for each destination and then by multiplexing data having the same timing together; and
a separator which extracts a datum for each destination from the multiple signal, by multiplying the multiple signal by the orthogonal code for each destination.

2. The switching circuit according to claim 1, wherein the timing controller synchronizes the timings of the plurality of the data input in parallel when adjusting the timings of the plurality of the data.

3. The switching circuit according to claim 1, wherein the multiplexer has a first plurality of multipliers which multiplies each of the data whose timings have been adjusted in the timing controller by the orthogonal code, and a multiplex circuit which generates the multiple signal by synthesizing outputs of the plurality of the multipliers, and wherein the separator has a second plurality of multipliers which multiplies the multiple signal by the orthogonal code.

4. The switching circuit according to claim 3, further comprising an orthogonal-code-setting register which can arbitrarily set an orthogonal code and which supplies the set orthogonal code to the first multiplier and the second multiplier.

5. The switching circuit according to claim 1, wherein the data are packets having variable lengths, and the timing controller uniformizes bus widths of the packets by adding an empty datum as needed when adjusting the timings of the plurality of the data.

6. The switching circuit according to claim 1, wherein the timing controller has a dual port storage section in which the data are written in an assigned address, and the written data are synchronized to be read out in an address sequence; and
an address controller which assigns an address in which the data are written in the dual port storage section so that data having the same destination existing at the same timing are each read out at different timings.

7. The switching circuit according to claim 1, wherein the data are packets having variable lengths, and the timing controller determines a destination based on a header of the packets.

8. The switching circuit according to claim 1, further comprising a storage section where data will remain and which temporarily accumulates the multiple signal generated in the multiplexer therein and sequentially supplies the multiple signal to the separator.

9. A switching method comprising:
receiving a plurality of data which have been input in parallel, and adjusting the timings of the plurality of the data so that data having the same destination do not exist at the same timing;
generating a multiple signal by multiplying the data whose timings have been adjusted by an orthogonal code that has been determined for each destination, and then by multiplexing data having the same timing together; and
extracting a datum for each destination from the multiple signal, by multiplying the multiple signal by the orthogonal code for each destination.

10. The switching method according to claim 9, comprising synchronizing the timings of the data input in parallel when adjusting the timings of the plurality of the data.

11. The switching method according to claim 9, wherein the data are packets having variable lengths, and bus widths of the packets are uniformized by adding an empty datum as needed when adjusting the timings of the plurality of the data.

12. The switching method according to claim 9, wherein adjusting the timings of the plurality of the data includes using dual port storage means for writing the data in an assigned address, and for synchronizing the written data so that the data can be read out in an address sequence, and
assigning an address in which the data are written in the dual port storage means so that data having the same destination existing at the same timing are read out at different timings.

13. The switching method according to claim 9, wherein the data are packets having variable lengths, and a destination is determined based on a header of the packets.

14. A switching circuit comprising:
timing control means which receives a plurality of data that have been input in parallel and adjusts the timings of the plurality of the data so that data having the same destination do not exist at the same timing;
multiplexing means which generates a multiple signal by multiplying the data of whose timings have been adjusted in the timing control means by an orthogonal code that has been determined for each destination and then by multiplexing data having the same timing together; and
separating means which extracts a datum for each destination from the multiple signal, by multiplying the multiple signal by the orthogonal code for each destination.
